(19) United States
(12) Patent Application Publication
(10) Pub. No.: US 2010/0028779 A1
(43) Pub. Date: Feb. 4, 2010

(54) Porous Polyimide Membrane, Battery Separator, Battery, and Method

(75) Inventors: Qing GONG, Shenzhen (CN); Weiguo Yang, Shenzhen (CN); Lin Jiang, Shenzhen (CN); Jingyu Ren, Shenzhen (CN)

Correspondence Address: BRINKS HOFER GILSON & LIONE, P.O. BOX 10395, CHICAGO, IL, 60610, US

(73) Assignee: BYD Co., Ltd., Shenzhen (CN)

(21) Appl. No.: 12/533,664

(22) Filed: Jul. 31, 2009

(30) Foreign Application Priority Data
Jul. 31, 2008 (CN) 20081014429.2
Aug. 29, 2008 (CN) 200810210165.6

(51) Int. Cl. H01M 4/58; C08J 9/16; C08G 73/10

(52) U.S. Cl. 429/231.95; 521/56; 521/183

(57) ABSTRACT

A porous polyimide membrane is provided. The volume of pores with a diameter of between about 50 and about 300 nm is more than about 40%, preferably more than 75% of the total pore volume in the membrane. A method for preparing a porous polyimide membrane comprises: preparing a porous polyamide acid membrane; stretching the porous polyamide acid membrane to form a stretched membrane; and imidizing the stretched membrane to form a porous polyimide membrane. The volume of the pores with a diameter of about 50-300 nm is more than about 40%, preferably more than 75% of the total pore volume in the porous polyimide membrane.

The present application claims priority to Chinese Patent Applications No. 200810144429.2, filed Jul. 31, 2008, and No. 200810210165.6, filed Aug. 29, 2008, the entire disclosures of which are hereby incorporated by reference.

### FIELD OF THE DISCLOSURE

The present disclosure relates to a porous polyimide membrane, a battery separator, and a battery comprising such a separator. The disclosure also relates to a method for preparing a porous polyimide membrane, and a method for preparing a battery using such membrane as a separator.

### BACKGROUND OF THE DISCLOSURE

Liquid electrolyte lithium batteries have been used widely. However, there are still hidden dangers as liquid electrolyte is packed in a sealed metal shell. When batteries overheat, the internal pressure of the batteries may increase, which may cause an explosion. For example, when batteries are operating in a high temperature environment, heat may transfer from the environment to the battery via the metal shell. Also batteries may produce heat at high discharge currents. Therefore, further application of liquid electrolyte lithium batteries can be limited. A crucial issue is to improve the safety of lithium batteries.

One of the approaches to improve the safety of lithium batteries is to shut down the current when the temperature increases above a certain level. In this approach, battery separators play an important role. Porous polymer membranes have been used as separators. The membrane's performance affects the battery's properties, productivity, and safety. In general, the membranes melt at a certain temperature, which is called shutdown temperature or self-closing temperature. The melting will cause a closure of the porous structures and a rapid increasing of the electric resistance. Therefore the current is shut down. When the temperature of the battery exceeds the heat resistant temperature of the membrane, the membrane will be destroyed completely. Then a short circuit will happen as a result of the direct contact between the anode and cathode. This temperature is called meltdown temperature. As is known, it is desirable to have a relatively low shutdown temperature and a relatively high meltdown temperature for improved battery safety properties, particularly for batteries exposed to high temperatures during the operating. Commonly used separators, such as polyethylene (PE) and polypropylene (PP), have a melting temperature lower than 200° C. (the self-closing temperature of PE membrane is about 130-140° C., and the self-closing temperature of PP membrane is about 170° C.). In some cases, such as at a high outside temperature, the temperature of the battery may continue to rise, although the current is shut down. Then the membrane may be destroyed completely and a short circuit happens, which causes explosion or fire. Therefore, there may be safe problems when using PE membrane or PP membrane as separators.

High capacity batteries are becoming more and more desirable. However, high capacity batteries usually require a relatively low internal resistance of the batteries, therefore may produce more heat. It is important to improve the safety performance of the high capacity batteries.

Patent JP11310658A2 discloses a porous polyimide membrane and a method for preparing thereof. The method comprises: laminating a membrane prepared from a polyamide acid solution and a porous membrane, and immersing the laminated membrane into a poor solvent to prepare a porous polyimide membrane. The pore in the membrane has a pore diameter of about 10-10,000 nm. The porous membranes include polyolefin or its derivative membranes, which are commonly used as battery separators. The membrane prepared by this method has a better heat resistance. However, when the temperature is higher than the melting point of polyolefin materials (about 180° C.), the polyolefin materials would melt and the polyimide layer laminated on the polyolefin membranes would fall off. Therefore safety issues still exist when the porous polyimide membranes are used as battery separators. Furthermore, the polyimide membranes prepared by this method do not have good gas permeability.

Patent CN101000951A discloses a method for preparing a porous polyimide membrane for battery separators. The method comprises: forming a membrane from a solution containing a polyimide, a pore-forming material and a solvent, removing the pore-forming material at a temperature lower than the glass transition temperature of polyimide, and stretching the porous polyimide membrane biaxially. The pore-forming material includes any kind of materials that are compatible with the membrane and can be removed at a temperature lower than the glass transition temperature of the membrane. For example, the pore-forming material can be nonvolatile organic solvents such as nonane, decane, undecane, dodecane, liquid paraffin and mineral oil. Micropores are formed in the polyimide membrane by removing the pore-forming material.

It would be desirable to develop a porous polymer membrane with appropriate permeability, heat resistance, mechanical properties, etc.

### SUMMARY OF THE DISCLOSURE

In one aspect, a porous polyimide membrane is provided. The volume of pores with a diameter of between about 50 and about 300 nm is more than about 40%, preferably more than 75% of the total pore volume.

In another aspect, a method for preparing a porous polyimide membrane comprises: preparing a porous polyamide acid membrane; stretching the porous polyamide acid membrane to form a stretched membrane; and imidizing the stretched membrane to form a porous polyimide membrane. The volume of the pores with a diameter of about 50-300 nm is more than about 40%, preferably more than 75% of the total pore volume in the membrane.

In yet another aspect, a lithium battery comprises a shell, an anode, a cathode, an electrolyte in contact with the anode and the cathode, and at least one separator disposed between the anode and the cathode. The anode, the cathode, the electrolyte, and the separator are disposed in the shell. The shell is sealed. The separator comprises a porous polyimide membrane. The volume of the pores with a diameter of about 50-300 nm is more than about 40%, preferably more than 75% of the total pore volume in the membrane.

### BRIEF DESCRIPTION OF THE DRAWINGS

FIG. 1 is a scanning electron microscope (SEM) photograph of the porous polyamide acid membrane prepared in example 1, magnified by 5000 times.

FIG. 2 is a scanning electron microscope (SEM) photograph of the stretched porous polyimide membrane prepared in example 1, magnified by 5000 times.

### DETAILED DESCRIPTION OF THE PREFERRED EMBODIMENTS

According to the present disclosure, a porous polyimide membrane is provided. The volume of the pores with a diameter of about 50-300 nm is more than about 40%, preferably more than 75% of the total pore volume. The volume of the pores with a pore diameter of less than about 50 nm or more than about 300 nm is less than about 60% of the total pore volume.

The porosity of the membrane can be about 10-60%. The porosity refers to the volume percentage of the pores in the total volume of the porous polyimide membrane. The porosity was measured by a mercury intrusion porosimeter in the present disclosure. The membrane has a thickness of about 8-200 μm. The membrane has a tensile strength of about 50-300 MPa. The membrane has an air permeability under about 200 seconds/100 cc. When the stretched porous polyimide membrane is used as a battery separator, the preferred porosity is about 25-45%. The thickness is about 5-50 μm, preferably about 12-25 μm. The air permeability is about 10-200 seconds/100 cc, preferably about 20-120 seconds/100 cc.

A method for preparing a stretched porous polyimide membrane is also provided. The method comprises: preparing a porous polyamide acid membrane; stretching the porous polyamide acid membrane to form a stretched membrane; and imidizing the stretched membrane to form a porous polyimide membrane. The pore volume of the pores with a pore diameter of about 50-300 nm is more than about 40%, preferably more than 75% of the total pore volume in the membrane.

The step of preparing a porous polyamide acid membrane can further comprise: preparing a mixture of a polyamide acid, a pore-forming material, and a solvent; forming a porous polyamide acid sheet from the mixture; and solidifying the polyamide acid sheet to provide a porous polyamide acid membrane.

The polyamide acid can be any suitable polyamide acid. The preferred example is selected from the group consisting of poly(pyromellitic amide acid), poly(biphenyltetracarboxylic amide acid), poly(benzophenonetetracarboxylic amide acid), and combinations thereof.

The solvent can be any solvent that dissolves polyamide acid. The preferred solvent is selected from the group consisting of N-methyl-2-pyrrolidinone (NMP), N,N-dimethylacetamide (DMA), tetrahydrofuran (THF), N,N-dimethylformamide (DMF), m-cresol, dimethyl sulfoxide (DMSO), methanol, and combinations thereof.

Pores can be formed by two methods. In one method, the pore-forming material is removed by reacting with a reagent, such as the solidifying agent. The polyamide acid is soluble in the solvent, and the pore-forming material is not soluble or only slightly soluble. In another method, the pore-forming material is removed by dissolving in a reagent, such as the solidifying agent, while polyamide acid is not soluble or only slightly soluble in this reagent. The term “soluble” means that solubility is not less than 1 g solute per 100 g solvent. The term “slightly soluble” means that solubility is less than 1 g solute per 100 g solvent and more than 0.01 g solute per 100 g solvent. The term “not soluble” means that solubility is less than 0.01 g solute per 100 g solvent.

In the first pore-forming method, the pore-forming material can be any suitable inorganic material. The preferred example is selected from the group consisting of alkaline earth metal hydroxides, aluminum hydroxide, alkali metal phosphates, sodium tripolyphosphates, and combinations thereof. The average particle diameter can be in a range of from about 0.01 to about 2 μm. The alkaline earth metal hydroxide can be selected from the group consisting of magnesium hydroxide, calcium hydroxide, and combinations thereof. The alkali metal phosphate can be selected from the group consisting of trisodium phosphate, tripotassium phosphate, and combinations thereof. The solidifying agent can be any suitable agent that only reacts with the pore-forming material. For example, the agent is selected from the group consisting of hydrochloric acid, sulfuric acid, phosphoric acid, and combinations thereof.

According to the method in the present disclosure, the concentration of hydrochloric acid can be about 5-35% (wt). The concentration of sulfuric acid can be about 5-98% (wt). The concentration of phosphoric acid can be about 5-98% (wt).

In the second pore-forming method, the pore-forming material can be any suitable organic reagent. For example, the pore-forming material can be selected from the group consisting of C₅₋₁₅ saturated carboxylic acids, glycol benzoates, benzenedicarboxylate di-(C₁₃₋₃₀ alkyl)esters, and polyhydric alcohol mono methyl ether acetates, and combinations thereof. The solidifying agent can be any suitable organic solvent. The example is selected from the group consisting of methanol, ethanol, methyl ether, ethyl ether, acetone, methyl propanediol, and combinations thereof. Preferably, the C₅₋₁₅ saturated carboxylic acid is selected from the group consisting of pentanoic acid, hexanoic acid, heptanoic acid, octanoic acid, nonanoic acid, decanoic acid, isomers thereof, and combinations thereof. The glycol benzoate is selected from the group consisting of diethylene glycol dibenzoate (DEDB), dipropylene glycol dibenzoate, ethylene glycol benzoate, propylene glycol benzoate, and combinations thereof. The benzenedicarboxylate di-(C₁₃₋₃₀ alkyl)ester is selected from the group consisting of dipentyl terephthalate, isophthalate dihexyl ester, phthalate dinonyl ester, and combinations thereof. The polyhydric alcohol mono methyl ether acetate is selected from the group consisting of propylenediol monomethyl ether acetate, ethyleneglycol monomethyl ether acetate, and combinations thereof.

According to the present disclosure, preferably, the weight ratio of the pore-forming material to polyamide acid is in a range of from about 0.01:1 to about 0.3:1. The weight ratio of polyamide acid to the solvent is in a range of from about 1:4.5 to about 1:10. The weight ratio of polyamide acid to the solidifying agent is in a range of from about 1:20 to about 1:200, preferably in a range of from about 1:40 to about 1:50.

According to the present disclosure, the solidifying can comprise dipping the polyamide acid sheet into the solidifying agent at a temperature in a range of from about 0 to about 50° C. The dipping time is about 20-120 minutes. During this process, the polyamide acid membrane is solidified, the pore-forming material is removed, and a porous polyamide acid membrane is formed.

According to the method in the present disclosure, the polyamide acid can be purchased or be prepared by a reaction between a tetracarboxylic dianhydride and an organic diamine in a solvent. In the preparing process, the pore-forming material can be added at any phase, provided that the pore-forming material can mix with polyamide acid solution uniformly. Preferably, the pore-forming material is added before the reaction.

Preferably, the method for preparing a polyimide membrane comprises: mixing a tetracarboxylic dianhydride, an organic diamine, a pore-forming material and a solvent to prepare a uniform mixture; preparing a polyamide acid sheet from the mixture; drying the sheet at a temperature lower than the glass transition temperature of the polyamide acid; dipping the dried polyamide acid sheet into a solidifying agent in order to remove the pore-forming material and provide a polyamide acid membrane; stretching the prepared porous polyamide acid membrane; and imidizing the stretched porous polyamide acid membrane to provide a porous polyimide membrane.

According to the method in present disclosure, preferably, the molar ratio of the tetracarboxylic dianhydride to organic diamine is in a range of from about 0.8 to about 1.2. More preferably, the ratio is in a range of from about 1.00 to about 1.02. The weight ratio of the total amount of the tetracarboxylic dianhydride and the organic diamine to the pore-forming material is in a range of from about 1:0.01 to about 1:0.3. The weight ratio of the total amount of the tetracarboxylic dianhydride and the organic diamine to the solvent is in a range of from about 1:4.5 to about 1:10.

According to the method in the present disclosure, preferably, the temperature for the condensation reaction is in a range of from about 20 to about 70° C. The reaction time is in a range of from about 3 to about 15 hours.

According to the present disclosure, the method for forming a polyamide acid membrane from a polyamide acid solution can be any method known in this field. For example, the method can comprise coating the mixture of a polyamide acid, a pore-forming material and a solvent on a substrate; drying the coated substrate, and removing the solvent. Typically, the polyamide acid membrane prepared in these methods is a non-porous membrane or a membrane with low porosity, which would not meet the requirements of porosities, pore diameters and pore distributions for battery separators.

In the process of coating polyamide acid solution onto a substrate, preferably, the temperature is in a range of from about 10 to about 40° C. The relative humidity is in a range of from about 20 to about 80%.

The coating method can be any method known in this field, such as spin-coating, spread coating, flow casting, dip coating, and so on. The thickness of the polyimide membrane depends on the coating amount of the polyamide acid solution. The thickness of the porous polyimide membrane prepared in the present disclosure is in a range of about 8-200 μm. When a stretched porous polyimide membrane is used as battery separators, in general case, the final thickness of the porous polyimide membrane is about 5-50 μm. The experiments showed that the final thickness of the stretched porous polyimide membrane is about 5-50 μm when the thickness of the porous polyamide acid membrane is controlled at about 10-60 μm. It is easy for technical personnel in this field to obtain a porous polyamide acid membrane with a predetermined thickness by controlling the coating amount of polyamide acid solution.

The substrate can be any suitable material. The examples are stainless steel plates, polyethylene films, polypropylene films, polyester films, copper foil, and aluminum foil.

The method for removing solvents can be any suitable method known in this field, such as air drying, heat-drying, vacuum drying, and so on. The drying temperature can be about 20-150° C. The drying time can be about 5-20 minutes.

In order to improve the quality of the final porous polyimide membrane, the polyamide acid solution can be vacuum degassed for about 1-12 hours. Preferably, vacuum degassing is performed for about 1-2 hours in order to remove bubbles in the solution. The working pressure is preferably about 0.001-0.1 Mpa. The polyamide acid solution should be non-volatile or only slightly volatile in that pressure.

In general, the pore diameter of the prepared porous polyamide acid membrane is about 10-10,000 nm, preferably about 50-2000 nm. The pore diameter is measured by a mercury intrusion method known in this field.

The stretching process can be performed at a temperature of about 0-200° C. Preferably, the porous polyamide acid membrane is stretched by a factor of from about 1.05 to about 2 times in at least one direction.

The stretching can be conducted monoaxially or biaxially. The monoaxial stretching indicates stretching membrane along a longitudinal or a transverse direction. The longitudinal direction is parallel to the forward movement of membrane during membrane processing. The direction is also called machine direction (MD). The transverse direction (TD) is orthogonal to both the longitudinal and the horizontal surface of the membrane. The biaxial stretching means stretching membrane along longitudinal and transverse direction simultaneously or sequentially. Technical personnel in this field can choose proper stretching speed for a certain stretching ratio. A uniform stretching speed is preferred and the speed has no effect on the structure of the pores and the pore diameter distribution of the membrane.

According to the present disclosure, in order to improve the quality of the porous polyimide membrane and avoid the adverse effects of the solidifying agents, preferably, the method can further comprise: cleaning the prepared porous polyamide acid membrane with a cleaning agent. The cleaning agent is selected from the group consisting of C₂₋₈ alcohols, ketones, and combinations thereof. Preferably, the agent is selected from the group consisting of ethanol, acetone, and combinations thereof. The cleaning temperature can be about 0-60° C. Preferably, the cleaning temperature is about 20-50° C. The cleaning method can be selected from the group consisting of rinsing, soaking, and combinations thereof. The membrane can be rinsed about 3-5 times. The soaking time can be about 3-6 hours. In the soaking process, ultrasonic can be used as an auxiliary method.

In the present disclosure, the conventional conditions of the imidization process can be employed. The detailed operating methods have been widely-known in this field, such as heating the stretched porous polyamide acid membrane at about 70-400° C. for about 2-7 hours. In the imidization process, the temperature can rise to about 70-400° C. by direct heating or programmed heating. Preferably, the temperature rises to about 70-400° C. by programmed heating at a rate of about 4-8° C./minute. The imidization reaction can be more complete by this process. More preferably, the imidization process can comprise holding the temperature for about 0.5-4 hours at about 70-200° C., then holding the temperature for about 0.5-3 hours at about 200-400° C. using programmed heating. The experiments showed that the imidization process in the above-mentioned conditions had no effect on the distribution and the size of pores. The prepared polyimide membrane maintained the porous structure from the polyamide acid membrane.

The conversion rate of the imidization process can be improved by increasing the reaction temperature and prolonging the reaction time. Under the conditions mentioned above, the conversion rate of the polyamide acid converting to polyimide is more than 99%. In the present disclosure, the method for converting polyamide acid to polyimide is conventional, thus there is no special requirements for the amount of polyamide in the embodiments of the present disclosure. Additionally, a small amount of polyamide acid in the polyimide membrane has no significant effects on the heat resistance, permeability and heat shrinkage ratio of the porous polyimide membrane. Therefore, the porous polyimide membrane can contain less than about 2% of the polyamide acid.

A condensation reaction between dicarboxylic anhydrides and organic diamines is employed in the embodiments of the present disclosure. The dicarboxylic anhydrides include, but are not limited to: 3,3′,4,4′-biphenyltetracarboxylic dianhydride (s-BPDA), 3,3′,4,4′-benzophenonetetracarboxylic dianhydride (BTDA), 1,2,4,5-benzene tetracarboxylic dianhydride (PMDA), ODPA and 2,2-bis[4-(3,4-dicarboxyphenoxy)phenyl]propane dianhydride (BPADA). The organic diamines include, but are not limited to: 4,4′-oxydianiline (4,4′-ODA), 3,4′-oxydianiline (3,4′-ODA), p-phenylene diamine (PDA), m-phenylenediamine (MDA), 3,3′-diamino diphenylsulfone and 4,4′-diamino diphenylsulfone.

The molar ratio of the polycarboxylic acids or their derivatives to the organic diamines can be about 0.8-1.2, preferably about 1.00-1.02. The weight ratio of the solvent to the total amount of the polycarboxylic acids or their derivatives, and the organic diamines can be about 4.5-10. The temperature of the condensation reaction can be about 20-70° C. The time of the condensation reaction can be about 3-15 hours.

In the present disclosure, the polyimide can be any polymers containing imide group in the repeating units. Preferably, the polyimide has a formula:

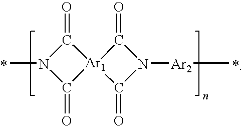

Preferably, the group Ar₁ is selected from the aryls listed as follows:

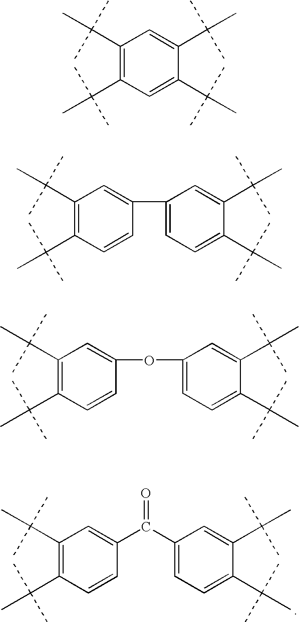

The diamine can have a structure of NH₂—Ar₂—NH₂, The group Ar₂ can be selected from the following aryls:

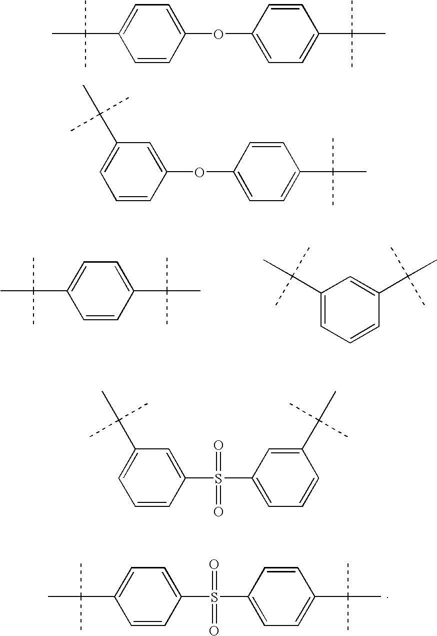

The polymerization degree “n” can be about 50-10000. The thermal decomposition temperature is about no lower than 420° C.

As known in this field, polyimides are insoluble macromolecule polymers in most solvents and its polymerization degree is difficult to be determined accurately. However, the polymerization degree is closely related to the intrinsic viscosity of a reaction intermediate, polyamide acid. Research shows that the polyimide with a required polymerization degree and physical properties can be prepared by controlling the intrinsic viscosity of polyamide acid. The intrinsic viscosity is a physical parameter independent of the measurement conditions and can reflect the polymerization degree of polyamide acid. Thus, the intrinsic viscosity of polyamide acid is usually used to indicate the polymerization degree of polyamide acid and polyimide in this field. In the present disclosure, the desired polyimide membrane can be obtained when the intrinsic viscosity of corresponding polyamide acids is controlled at about 100-200 mL/g, preferably about 140-190 mL/g.

Preferably, the polyimide can be selected from the group consisting of poly(pyromellitic imide), poly(biphenyltetracarboxylic imide), poly(benzophenonetetracarboxylic imide), and combinations thereof. Preferably, the poly(pyromellitic imide) can be selected from the group consisting of poly(N-phenyl-pyromellitic imide), poly(N-biphenyl-pyromellitic imide), poly(N-diphenyloxide-pyromellitic imide), and combinations thereof. The poly(biphenyltetracarboxylic imide) can be selected from the group consisting of poly(N-phenyl-biphenyltetracarboxylic imide), poly(N-biphenyl-biphenyltetracarboxylic imide), poly(N-biphenyloxide-biphenyltetracarboxylic imide), and combinations thereof. The poly(benzophenonetetracarboxylic imide) can be selected from the group consisting of poly(N-phenyl-benzophenonetetracarboxylic imide), poly(N-biphenyl-benzophenonetetracarboxylic imide), poly(N-biphenyloxide-benzophenonetetracarboxylic imide), and combinations thereof.

According to one of the embodiments in the present disclosure, a stretched porous polyimide membrane can be prepared by the steps as follows:

(1) The tetracarboxylic dianhydride and diamine are added into a solvent at a molar ratio of about (0.8-1.2):1 to prepare a polyamide acid solution. The concentration of the solution is about 5-40% (wt). The mixture is stirred at about 20-70° C. for about 3-15 hours. Then a pore-forming material is added. The weight ratio of the pore-forming material to the prepared polyamide acid is about (0.01-0.3):1. The polyamide acid solution is degassed under vacuum at the same temperature for about 1-12 hours.

(2) The polyamide acid solution is coated on a stainless steel plate or a glass substrate at a temperature of about 10-40° C. and at a relative humidity of about 20-80%. The coated substrate is dried under about 20-200° C. The polyamide acid sheet with a thickness of about 5-50 μm is prepared after the solvent is removed.

(3) The coated substrate is dipped into a solidifying agent for about 20-120 minutes to prepare a porous polyamide acid membrane. The temperature of the solidifying agent is about 10-50° C.

(4) The porous polyamide acid membrane is stretched biaxially or monoaxially to prepare a stretched porous polyamide acid membrane. The stretched porous polyamide acid membrane is soaked in a cleaning agent for about 3-6 hours at about 10-50° C. After the stretched porous polyamide acid membrane is dried, an imidization process is performed under a temperature gradient. The polyamide acid is converted to polyimide in N₂, Ar or vacuum. The temperature gradient comprises heating up the membrane to about 100-200° C. and the temperature is held for about 0.5-1.5 hours; heating up to about 180-250° C. and holding for about 0.5-1.5 hours; heating up to about 230-280° C. and holding for about 0.5-1.5 hours, and heating up to about 260-350° C. and holding for about 0.5-1.5 hours.

According to the basic knowledge of organic synthesis, the polyimide membrane can be prepared using the method provided by the present disclosure. It also can be characterized by infrared spectra. In infrared spectrum, the strong peak close to 1720 cm⁻¹ is the stretch vibration absorption of C═O bonds. The medium strong peak close to 1380 cm⁻¹ is the stretch vibration absorption spectra of C—N bond. The appearance of these peaks in infrared spectra can indicate the existence of the polyimide. The infrared spectra can be obtained by a potassium bromide coating method using NEXUS470 Fourier transform infrared spectrometry made by Nicolet Company, U.S.A. The measurement method is widely-known in this field. The synthetic method of polyimide used in the present disclosure is very mature, so the structure of polyimide membrane is not characterized in the embodiments.

The pore size, porosity and permeability of the polyimide membranes in the present disclosure are related to the concentrations of the polyamide acid solution, solidifying agent, film forming temperature and humidity. The properties of the porous polyimide membrane can be controlled by adjusting these conditions.

A lithium battery using the disclosed membranes as separators is also provided. The lithium battery comprises a shell, an anode, a cathode, an electrolyte in contact with the anode and the cathode, and at least one separator disposed between the anode and the cathode. The anode, the cathode, the electrolyte, and the separator are disposed in the shell. The shell is sealed. The separator comprises a porous polyimide membrane. The volume of the pores with a diameter of about 50-300 nm is more than about 40%, preferably more than 75% of the total pore volume in the membrane. The stretched porous polyimide membranes have favorable pore uniformity and permeability, thus, the lithium ion batteries may have a longer life and a better safety performance.

The present disclosure is further illustrated by the embodiments as follow. The main materials used in the embodiments comprise:
1,2,4,5-benzene tetracarboxylic dianhydride, made by Shanghai Syntheticresin Institute; 3,3′,4,4′-benzophenonetetracarboxylic dianhydride, made by Shanghai Syntheticresin Institute;
2,2-bis[4-(3,4-dicarboxyphenoxy)phenyl]propane dianhydride, made by Shanghai Syntheticresin Institute; 3,3′4,4′-Biphenyl tetracarboxylic acid dianhydride, made by Shanghai Chemical Reagent Company;
p-phenylene diamine, distributed by Shanghai Chemical Reagent Company; N,N-dimethylacetamide and N-methylpyrrolidone, made by Shanghai Reagent Plant.

### EXAMPLE 1

A method for preparing a microporous polyimide membrane is illustrated in this example.

(1) 4,4′-Diaminodiphenyl ether and 1,2,4,5-benzene tetracarboxylic dianhydride were added into 300 mL of N,N-dimethylacetamide according to a molar ratio of 1:1. The solid content was about 10% by weight (the solid content was the weight percentage of the generated polyamide acid in the total mixture). After the mixture was stirred at about 25° C. for about 8 hours, 3 g dipropylene glycol methyl ether acetate was added. The mixture was degassed under vacuum for about 1 hour to prepare a viscous mixture whose intrinsic viscosity was about 150 ml/g (measurement conditions: Ubbelohde viscometer, 30° C., solid content of 0.005 g/mL).

(2) The mixture was coated on a stainless steel plate at about 10° C. and at a relative humidity of about 50%. The coated stainless steel plate was dried at about 100° C. for about 20 minutes to prepare a polyamide acid sheet.

(3) The coated stainless steel plate was dipped into 100 mL of a solidifying agent at about 20° C. for about 60 minutes. The solidifying agent comprised ethanol, ether and acetone at a volume ratio of about 3:2:1. The polyamide acid sheet on the stainless steel plate was solidified to provide a membrane. In the meantime, pores were formed in the membrane. The membrane was dried at about 40° C. for about 20 hours. Then ultrasonic cleaning was applied at about 25° C. for about 1 hour. The membrane was dried at about 40° C. for about 20 hours again to prepare a porous polyamide acid membrane.

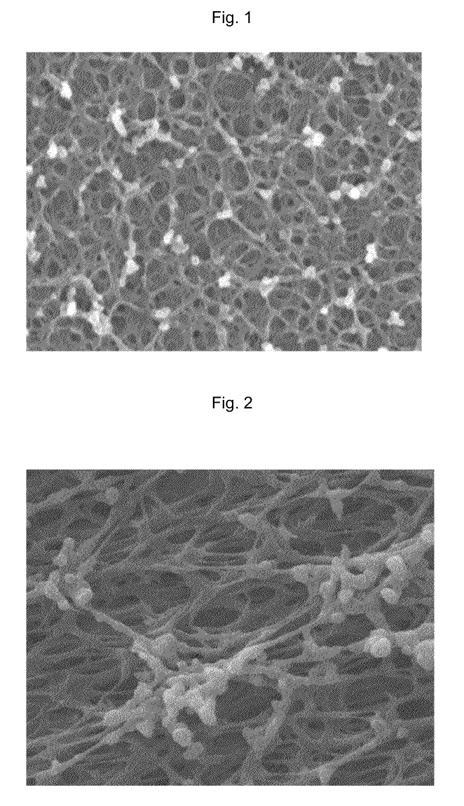

FIG. 1 is a SEM photograph showing the pore distribution of the prepared porous polyamide acid membrane. As shown in FIG. 1, the porous polyamide acid membrane had a three-dimensional network pore structure. The pores were distributed on the surface of the membrane and in the membrane. The pores were round or oval shape. They were connected with each other. The volume of the pores with a diameter of about 110-130 nm was 93% of the total pore volume, which showed that the pore size distribution of the porous polyamide acid membrane was uniform.

(4) The porous polyamide acid membrane was stretched by a factor of about 1.8 times in one direction at about 120° C.

(5) The imidization process was performed under an increasing temperature gradient. The stretched porous polyamide acid membrane was heated in N₂ to prepare a stretched porous polyimide membrane with a thickness of about 33 μm. The heating process comprised heating up to about 150° C. and holding for about 1 hour; heating up to about 200° C. and holding for about 1 hour; heating up to about 250° C. and holding for about 1 hour; and heating up to about 320° C. and holding for about 1 hour.

FIG. 2 is a SEM photograph showing the pore distribution of the stretched porous polyimide membrane. As showed in FIG. 2, the pores were distributed on the surface and in the membrane. They were still connected with each other.

### EXAMPLE 2

A method for preparing a stretched porous polyimide membrane is illustrated in this example.

A stretched porous polyimide membrane was prepared according to example 1. The difference was that 6 g of dipropylene glycol methyl ether acetate was added in step (1) in order to obtain a viscous mixture. The intrinsic viscosity of the viscous mixture was about 180 mL/g (measurement conditions: Ubbelohde viscometer, 30° C., solid content of 0.005 g/mL).

The pore size distribution of the porous polyamide acid membrane was measured by the mercury intrusion method. The volume of the pores with a diameter of about 160-190 nm was about 78% of the total pore volume, which showed that the pore diameter distribution of the porous polyamide acid membrane was uniform.

### EXAMPLE 3

A method for preparing a stretched porous polyimide membrane is illustrated in this example.

A stretched porous polyimide membrane was prepared according to example 1. The difference was, 5 g dipropylene glycol methyl ether acetate was added in step (1) in order to obtain a viscous mixture. The intrinsic viscosity of the viscous mixture was about 160 mL/g (measurement conditions: Ubbelohde viscometer, 30° C., a solid content of 0.005 g/mL).

The pore size distribution of the porous polyamide acid membrane was measured by the mercury intrusion method. The volume of the pores with a diameter of about 160-210 nm was about 88% of the total pore volume, which showed that the pore size distribution of the porous polyamide acid membrane was uniform.

### EXAMPLE 4

A method for preparing a stretched porous polyimide membrane is illustrated in this example.

(1) The 4,4′-diaminodiphenyl ether and 3,3′,4,4′-benzophenonetetracarboxylic dianhydride were added into 300 mL N,N-dimethylacetamide at a molar ratio of 1:1. The solid content was about 12% by weight. The mixture was stirred at about 40° C. for about 10 hours, then 4 g decanoic acid was added. The mixture was degassed under vacuum for about 1 hour and a viscous mixture with an intrinsic viscosity of about 188 mL/g was obtained (measurement conditions: Ubbelohde viscometer, 30° C., a solid content of 0.005 g/mL).

(2) The mixture was coated on a stainless steel plate at about 20° C. and at a relative humidity of about 60%. The coated stainless steel plate was dried at about 120° C. for about 10 minutes to provide a polyamide acid sheet.

(3) The coated stainless steel plate was dipped into 500 mL of a solidifying agent at about 25° C. for about 60 minutes. The solidifying agent comprised ethanol and ether at a volume ratio of about 2:1. The polyamide acid sheet was solidified to provide a membrane. In the meantime pores were formed. The membrane was dried at about 40° C. for about 5 hours. Then it was cleaned using ultrasonic in water at about 25° C. for 1 hour. It was dried at about 40° C. for about 20 hours again. The pore diameter of the porous polyamide acid membrane was measured with the mercury intrusion method. The volume of the pores with a diameter of about 275-300 nm was about 87% of the total pore volume, which showed that the pore size distribution of the porous polyamide acid membrane was uniform.

(4) The porous polyamide acid membrane was stretched biaxially by a factor of about 1.4 times at about 80° C.

(5) The method of a temperature gradient was used to realize the imidization process step by step. The stretched porous polyamide acid membrane was heated in N₂ to provide a stretched porous polyimide membrane with a thickness of about 26 μm. The heating process comprised heating up to about 160° C. and holding for about 1 hour; heating up to about 210° C. and holding for about 0.8 hour; heating up to about 230° C. and holding for about 1.2 hour; and heating up to about 320° C. and holding for about 1 hour. The pore diameter distribution of the stretched porous polyimide membrane was still uniform.

### EXAMPLE 5

A method for preparing a stretched porous polyimide membrane is illustrated in this example.

(1) 4,4′-diaminodiphenyl ether and 1,2,4,5-benzene tetracarboxylic dianhydride were added into 300 mL N-methyl-2-pyrrolidinone (NMP) at a molar ratio of about 1:1. The solid content was about 12% by weight. The mixture was stirred at about 25° C. for about 15 hours. Then about 1 g magnesium hydroxide and about 1.5 g aluminum hydroxide were added. The average particle diameter was about 0.05 μm. A viscous mixture with an intrinsic viscosity of about 143 mL/g was obtained (measurement conditions: Ubbelohde viscometer, 30° C., a solid content of about 0.005 g/mL).

(2) The mixture was coated on a stainless steel plate at about 30° C. and at a relative humidity of about 80%. The coated stainless steel plate was dried naturally for about 10 minutes to prepare a polyamide acid sheet.

(3) The coated stainless steel plate was dipped into a 600 mL solidifying agent at about 25° C. for about 80 minutes. The solidifying agent comprised hydrochloric acid and phosphoric acid at a volume ratio of about 2:1. The polyamide acid sheet was solidified to provide a membrane and pores were formed. The membrane was cleaned in water at about 25° C. for 10 hours. The pore diameter of the porous polyamide acid membrane was measured by the mercury intrusion method. The volume of the pores with a pore diameter of about 50-75 nm was about 80% of the total pore volume, which showed that the pore diameter distribution of the porous polyamide acid membrane was uniform.

(4) The porous polyamide acid membrane was stretched by a factor of about 1.7 times in the longitudinal direction first and then stretched by a factor of about 1.4 times in the transversal direction at about 120° C.

(5) The increasing temperature gradient was used to realize the imidization process step by step. The stretched porous polyamide acid membrane was heated in N₂ to prepare a stretched porous polyimide membrane with a thickness of about 35 μm. The heating process comprised heating up to about 80° C. and holding for about 1 hour; heating up to about 120° C. and holding for about 1 hour; heating up to about 180° C. and holding for about 1 hour; heating up to about 250° C. and holding for about 1 hour; and heating up to about 300° C. and holding for about 1 hour. The pore diameter distribution of the stretched porous polyimide membrane was still uniform.

### EXAMPLE 6

A method for preparing a stretched porous polyimide membrane is illustrated in this example.

(1) The 4,4′-diaminodiphenyl ether and 3,3′,4,4′-biphenyltetracarboxylic dianhydride were added into about 100 mL N-methyl-2-pyrrolidinone (NMP) at a molar ratio of about 1:1. The solid content was about 12% by weight. The mixture was stirred at about 55° C. for about 8 hours. Then about 1 g of a mixture of 1,2-benzenedicarboxylic acid dinonyl ester, decanoic acid and bis(2-ethylhexyl)phthalate (the volume ratio was about 4:3:1) was added. The mixture was degassed under vacuum for about 2 hours to provide a viscous mixture with an intrinsic viscosity of about 145 ml/g (measurement conditions: Ubbelohde viscometer, 30° C., a solid content of 0.005 g/ml).

(2) The mixture was coated on a stainless steel plate at about 30° C. and at a relative humidity of about 70%. The coated stainless steel plate was dried at about 100° C. for about 10 minutes to prepare a polyamide acid sheet.

(3) The coated stainless steel plate was dipped into 1,000 mL acetone at about 25° C. for about 30 minutes. The polyamide acid sheet was solidified and pores were formed to provide a porous polyamide acid membrane. Then the membrane was dried under about 40° C. for about 10 hours. The pore diameter of the porous polyamide acid membrane was measured by the mercury intrusion method. The volume of the pores with pore diameter of about 50-80 nm was about 79% of the total pore volume, which showed that the pore diameter distribution of the porous polyamide acid membrane was uniform.

(4) The porous polyamide acid membrane was stretched by a factor of about 1.7 times in the longitudinal direction firstly, and then by a factor of about 1.4 times in the transversal direction at about 120° C.

(5) An increasing temperature gradient was used to realize the imidization process step by step. The stretched porous polyamide acid membrane was heated in N₂ to provide a porous polyimide membrane with a thickness of about 23 μm. The heating process comprised heating up to about 150° C. and holding for about 1 hour; heating up to about 200° C. and holding for about 1 hour; heating up to about 250° C. and holding for about 1 hour; and heating up to about 300° C. and holding for about 1 hour. The pore diameter distribution of the stretched porous polyimide membrane was still uniform.

### EXAMPLE 7

A method for preparing a stretched porous polyimide membrane is illustrated in this example.

(1) The 4,4′-diaminodiphenyl ether and 3,3′,4,4′-biphenyltetracarboxylic dianhydride were added into about 100 mL N,N-dimethylformamide (DMF) at a molar ratio of about 1:1. The solid content was about 15% by weight. The mixture was stirred at about 20° C. for about 8 hours, then about 3 g of 1,2-benzenedicarboxylic acid dinonyl ester was added. The mixture was degassed under vacuum at about 15° C. for about 2 hours to provide a viscous mixture with an intrinsic viscosity of about 166 mL/g (measurement conditions: Ubbelohde viscometer, about 30° C., a solid content of about 0.005 g/mL).

(2) The mixture was coated on a stainless steel plate at about 30° C. and at a relative humidity of about 40%. The coated stainless steel plate was dried naturally for about 60 minutes to provide a polyamide acid sheet.

(3) The coated stainless steel plate was dipped into a 500 mL ethanol at about 25° C. for about 60 minutes. The polyamide acid sheet was solidified and pores were formed to provide a porous polyamide acid membrane. The membrane was dried at about 40° C. for about 10 hours. The pore diameter of the porous polyamide acid membrane was measured by the mercury intrusion method. The volume of the pores with a diameter of about 80-110 nm was about 85% of the total pore volume, which showed that the pore diameter distribution of the porous polyamide acid membrane was uniform.

(4) The porous polyamide acid membrane was stretched by a factor of about 1.1 times in the longitudinal direction firstly, and then by a factor of about 1.1 times in the transversal direction at about 120° C.

(5) An increasing temperature gradient was used to realize the imidization step by step. The stretched porous polyamide acid membrane was heated in N₂ to provide a porous polyimide membrane with a thickness of about 45 μm. The heating process comprised heating up to about 150° C. and holding for about 1 hour; heating up to about 200° C. and holding for about 1 hour; heating up to about 250° C. and holding for about 1 hour; and heating up to about 320° C. and holding for about 1 hour. The pore diameter distribution of stretched porous polyimide membrane was still uniform.

### EXAMPLE 8

A method for preparing a stretched porous polyimide membrane is illustrated in this example.

(1) 4,4′-diaminodiphenyl ether and 3,3′,4,4′-biphenyltetracarboxylic dianhydride were added into 100 mL N,N-dimethylacetamide (DMA) at a molar ratio of about 1:1. The solid content was about 10% by weight. The mixture was stirred at about 20° C. for about 4 hours, then about 2.5 g trisodium phosphate was added. The average particle diameter of trisodium phosphate was about 1.5 μm. The mixture was degassed under vacuum at about 15° C. for about 2 hours to provide a viscous mixture with an intrinsic viscosity of about 178 mL/g (measurement conditions: Ubbelohde viscometer, about 30° C., a solid content of about 0.005 g/mL).

(2) The mixture was coated on a stainless steel plate at about 30° C. and at a relative humidity of about 40%. The coated stainless steel plate was dried naturally for about 60 minutes to provide a polyamide acid sheet.

(3) The coated stainless steel plate was dipped into 1,000 mL sulfuric acid at about 25° C. for about 45 minutes. The polyamide acid sheet was solidified and pores were formed to provide a porous polyamide acid membrane. The sheet was dipped in acetone at about 30° C. for about 10 hours and dried at about 70° C. for about 10 hours. The pore diameter of the porous polyamide acid membrane was measured by the mercury intrusion method. The volume of the pores with a diameter of about 195-220 nm was about 89% of the total pore volume, which showed that the pore diameter distribution of the porous polyamide acid membrane was relatively uniform.

(4) The porous polyamide acid membrane was stretched by a factor of about 1.4 times in the longitudinal direction firstly, and then by a factor of about 1.1 times in the transversal direction at about 80° C.

(5) An increasing temperature gradient was used to realize the imidization step by step. The stretched porous polyamide acid membrane was heated in N₂ to provide a porous polyimide membrane with a thickness of about 18 μm. The heating process comprised heating up to about 150° C. and holding for about 1 hour; heating up to about 200° C. and holding for about 1 hour; heating up to about 250° C. and holding for about 1 hour; and heating up to about 320° C. and holding for about 1 hour. The pore diameter distribution of the stretched porous polyimide membrane was still relatively uniform.

CONTROL 1

A method for preparing a reference porous polyimide membrane is illustrated in this control.

1,2,4,5-benzene tetracarboxylic dianhydride, diaminodiphenyl ether and polystyrene that contained amino groups at one end of the polymer chain were added into about 100 mL N-methyl-2-pyrrolidinone (NMP) at a molar ratio of about 1:1:0.008. The weight-average molecular weight of the polystyrene was about 15000. The mixture was stirred at room temperature to provide a uniform solution with a solid content of about 10% by weight. Then the mixture was coated on an i-shaped coater apparatus to obtain a membrane with a thickness of about 0.5 mm.

The solvent was removed by heating the membrane at about 120° C. for about 2 hours. Then the membrane was heated up to about 300° C. with a temperature programmed at a speed of about 5° C./minute. The time of the imidization process was about 3 hours. The membrane was heated up to about 350° C. The temperature was held for about 1.5 hours, and then cooled to about 120° C. The membrane was stretched biaxially to prepare a battery separator. The stretching speed was about 10 mm/minute. The membrane was stretched by a factor of about 2 times in the longitudinal direction (MD) and about 2 times in the transversal direction (TD).

In the Fourier transform infrared spectroscopy, the strong peak close to 1720 cm⁻¹ was the stretch vibration absorption of C═O, and the medium strong peak close to 1720 cm⁻¹ was the stretch vibration absorption of C—N. Both of the peaks showed that the product contained imide groups. The absorption peaks at about 1600 cm⁻¹, 1575 cm⁻¹, 1490 cm⁻¹ and 1450 cm⁻¹ were the characteristic absorption of benzene ring, which showed that product contained benzene rings.

The pore diameter of the porous membrane was measured by the mercury intrusion method. The volume of the pores with a diameter of about 30-65 nm was about 45% of the total pore volume, which showed that the pore diameter distribution of the porous polyimide membrane was relatively not uniform.

### THE PROPERTIES OF THE MEMBRANES AND THE PERFORMANCE OF THE BATTERIES

1. Properties of the Membranes

(1) Thickness of the Membranes

The thickness of the stretched porous polyimide membranes was measured by a film thickness measuring device (Shanghai Liuleng Instrument Factory, Model CH-1-S/ST). Five random spots were measured in each membrane sample, and the values were averaged.

(2) Porosity and Average Pore Diameter of the Membranes

The porosity of the stretched porous polyimide membrane sample and the average pore diameter of the porous polyamide acid membrane before stretching were measured using a mercury porosimeter (DEMO AutoPore 9500, U.S.A).

(3) Tensile Strength and Elongation Ratio of the Membranes

The tensile strength and the elongation ratio of the stretched porous polyimide membrane sample were tested according to the method of the Chinese National Standard GB1040-79.

(4) Permeability of the Membranes

The permeability of the membrane sample was tested according to the standard method JIS P8117, which is known in the art.

The test results of examples 1-8 and control 1 were showed in Table 1.

TABLE 1

| | | Average | | Per- | | |
|---|---|---|---|---|---|---|
| | Thick- | Pore | Po- | meability | Elongation | |
| | ness | Diameter | rosity | (seconds/ | Ratio | Strength |
| Examples | (μm) | (nm) | (%) | 100 cc) | (%) | (MPa) |
| Example 1 | 33 | 125 | 65 | 165 | 3.2 | 90 |
| Example 2 | 19 | 175 | 33 | 139 | 4.8 | 51 |
| Example 3 | 14 | 195 | 46 | 20 | 7.4 | 79 |
| Example 4 | 26 | 290 | 29 | 41 | 6.9 | 83 |
| Example 5 | 35 | 60 | 55 | 69 | 10.4 | 129 |
| Example 6 | 23 | 68 | 37 | 123 | 6.9 | 150 |
| Example 7 | 45 | 97 | 24 | 100 | 7.8 | 63 |
| Example 8 | 18 | 210 | 71 | 59 | 3.5 | 97 |
| Control 1 | 18 | 50 | 50 | 450 | 3.6 | 70 |

As shown in Table 1, porosity, permeability and strength of the stretched porous polyimide membrane prepared according to the present disclosure were favorable and the pore diameter may meet the requirements of the lithium ion battery.

2. Performance of the Batteries

(1) Preparation of Anode

A mixture of about 100 g LiCoO₂, about 2 g vinylidene fluoride (PVDF), and about 3 g acetylene black was added into about 40 g N-methyl-2-pyrrolidone (NMP). LiCoO₂was used as a positive active material. PVDF was used as a bonding material. Acetylene black was used as a conductive agent. Then the mixture was stirred in a vacuum stirrer to provide a homogeneous positive slurry.

The slurry was coated on an aluminum foil evenly. Then the coated foil was dried at about 150° C., rolled and cut to provide an anode with a size of about 290 mm (length)×40 mm (width)×18 μm (thickness). The anode contained about 5.8 g of active material LiCoO₂.

(2) Preparation of Cathode

A mixture of about 100 g natural graphite, about 1.5 g polytetrafluoroethylene (PTFE), and about 1.5 g carboxymethyl cellulose (CMC) was added into about 100 g water. The natural graphite was used as a negative active material. PTFE was used as a bonding material. Then the mixture was stirred in a vacuum stirrer to provide a homogeneous negative slurry.

The slurry was coated evenly on both sides of a copper foil. Then the foil was dried at about 90° C., rolled and cut to provide a cathode with a size of about 395 mm (length)×41 mm (width)×12 μm (thickness). The cathode contained about 2.6 g natural graphite.

(3) Preparation of a Battery with the Membranes Prepared in the Present Disclosure

The anode, membrane and cathode were stacked in sequence and rolled together. Then they were placed into a cubic aluminum shell with a size of about 46 mm (length)×34 mm (width)×4.0 mm (thickness). The membranes were the porous polyimide membranes prepared in examples 1-8 and control 1.

About 2.4 g electrolyte was injected into the shell. The electrolyte was aged by conventional methods. The electrolyte comprised ethylene carbonate, ethyl methyl carbonate, and diethyl carbonate at a volume ratio of about 1:1:1. The electrolyte contained 1M of lithium hexafluorophosphate (LiPF₆). The lithium ion secondary battery was provided when the aluminum shell was sealed. The capacity of the batteries was about 750 mA.

(4) High Temperature Resistance of the Batteries

The batteries were charged up to 100% at 1C. Then the batteries were put into an oven. The temperature of the oven was raised from room temperature to about 150° C. and about 180° C. at a speed of about 5° C./min. When the voltage decreased for more than 0.2 V, a short circuit occurred.

(5) Battery Life Test

The battery underwent charge-discharge cycles for about 500 times at about 25° C.±5° C. The remaining capacity was measured. The larger the remaining capacity, the longer the battery life.

The batteries with the porous polyimide membranes in examples 1-8 and control 1 were tested by using the same method. The results are showed in Table 2.

TABLE 2

| | | | Remaining |
|---|---|---|---|
| | High Temperature Resistance Test | | Capacity |
| Sample No. | 150° C. | 180° C. | (%) |
| Sample 1 | No short-circuit and | No short-circuit and | 90 |
| | explosive situation | explosive situation | |
| Sample 2 | No short-circuit and | No short-circuit and | 88 |
| | explosive situation | explosive situation | |
| Sample 3 | No short-circuit and | No short-circuit and | 91 |
| | explosive situation | explosive situation | |
| Sample 4 | No short-circuit and | No short-circuit and | 87 |
| | explosive situation | explosive situation | |
| Sample 5 | No short-circuit and | No short-circuit and | 81 |
| | explosive situation | explosive situation | |
| Sample 6 | No short-circuit and | No short-circuit and | 80 |
| | explosive situation | explosive situation | |
| Sample 7 | No short-circuit and | No short-circuit and | 86 |
| | explosive situation | explosive situation | |
| Sample 8 | No short-circuit and | No short-circuit and | 90 |
| | explosive situation | explosive situation | |
| Control 1 | No short-circuit and | Explode | 65 |
| | explosive situation | | |

As shown in Table 2, the batteries with the disclosed porous polyimide membranes had better high-temperature resistance and a longer life time compared to the control.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

We claim:

1. A porous polyimide membrane, wherein the volume of pores with a diameter of between about 50 and about 300 nm is more than about 40% of the total pore volume.

2. The porous polyimide membrane of claim 1, wherein the volume of pores with a diameter of between about 50 and about 300 nm is more than about 75% of the total pore volume.

3. The porous polyimide membrane of claim 1, wherein the membrane has an air permeability in a range of from about 10 to about 200 seconds/100 cc.

4. The porous polyimide membrane of claim 1, wherein the membrane has a thickness in a range of from about 5 to about 50 μm.

5. A method for preparing a porous polyimide membrane, comprising:
preparing a porous polyamide acid membrane;
stretching the porous polyamide acid membrane to form a stretched membrane; and
imidizing the stretched membrane to form a porous polyimide membrane;
wherein the volume of the pores with a diameter of between about 50 and about 300 nm is more than about 40% of the total pore volume in the porous polyimide membrane.

6. The method of claim 5, wherein the stretching is carried out at a temperature in a range of from about 0 to about 200° C.

7. The method of claim 5, wherein the porous polyamide acid membrane is stretched by a factor of from about 1.05 times to about 2 times in at least one direction.

8. The method of claim 5, wherein the imidizing comprises a first step and a second step;
wherein the first step is carried out at a temperature of about 70-200° C. for about 0.5-4 hours, and the second step is carried out at a temperature of about 200-400° C. for about 0.5-3 hours.

9. The method of claim 5, wherein the step of preparing a porous polyamide acid membrane comprises:
preparing a mixture of a polyamide acid, a pore-forming material, and a solvent;
forming a porous polyamide acid sheet from the mixture; and
solidifying the polyamide acid sheet to provide a porous polyamide acid membrane.

10. The method of claim 9, wherein the polyamide acid is selected from the group consisting of poly(pyromellitic amide acid), poly(biphenyltetracarboxylic amide acid), poly(benzophenonetetracarboxylic amide acid), and combinations thereof.

11. The method of claim 9, wherein the solvent is selected from the group consisting of N-methyl-2-pyrrolidinone (NMP), N,N-dimethylacetamide (DMA), tetrahydrofuran (THF), N,N-dimethylformamide (DMF), m-cresol, dimethyl sulfoxide (DMSO), methanol, and combinations thereof.

12. The method of claim 9, wherein the polyamide acid is soluble in the solvent, and the pore-forming material is not soluble or only slightly soluble in the solvent.

13. The method of claim 9, wherein the pore-forming material is selected from the group consisting of alkaline earth metal hydroxides, aluminum hydroxide, alkali metal phosphates, sodium tripolyphosphate, C₅₋₁₅ saturated carboxylic acids, glycol benzoates, benzenedicarboxylate di-(C₁₃₋₃₀ alkyl)esters, and polyhydric alcohol mono methyl ether acetates, and combinations thereof.

14. The method of claim 13, wherein the pore-forming material is selected from the group consisting of alkaline earth metal hydroxides, aluminum hydroxide, alkali metal phosphates, sodium tripolyphosphate, and combinations thereof;
wherein the pore-forming material has an average particle diameter in a range of from about 0.01 to about 2 μm.

15. The method of claim 13, wherein the alkaline earth metal hydroxide is selected from the group consisting of magnesium hydroxide, calcium hydroxide, and combinations thereof;
wherein the alkali metal phosphate is selected from the group consisting of trisodium phosphate, tripotassium phosphate, and combinations thereof;
wherein the C₅₋₁₅ saturated carboxylic acid is selected from the group consisting of pentanoic acid, hexanoic acid, heptanoic acid, octanoic acid, nonanoic acid, decanoic acid, isomers thereof, and combinations thereof;
wherein the glycol benzoate is selected from the group consisting of diethylene glycol dibenzoate (DEDB), dipropylene glycol dibenzoate, ethylene glycol benzoate, propylene glycol benzoate, and combinations thereof;
wherein the benzenedicarboxylate di-(C₁₃₋₃₀ alkyl)ester is selected from the group consisting of dipentyl terephthalate, isophthalate dihexyl ester, phthalate dinonyl ester, and combinations thereof; and
wherein the polyhydric alcohol mono methyl ether acetate is selected from the group consisting of propylenediol monomethyl ether acetate, ethyleneglycol monomethyl ether acetate, and combinations thereof.

16. The method of claim 9, wherein a solidifying agent is used in the step of solidifying;
wherein the solidifying agent is selected from the group consisting of hydrochloric acid, sulfuric acid, phosphoric acid, methanol, ethanol, methyl ether, ethyl ether, acetone, methyl propanediol, and combinations thereof.

17. The method of claim 16, wherein the solidifying comprises dipping the polyamide acid sheet into the solidifying agent at a temperature in a range of from about 0 to about 50° C.; and the dipping time is about 20-120 minutes.

18. The method of claim 16, wherein the pore-forming material is soluble in the solidifying agent, and the polyamide acid is not soluble or only slightly soluble in the solidifying agent.

19. The method of claim 9, wherein the weight ratio of the pore-forming material to the polyamide acid is in a range of from about 0.01:1 to about 0.3:1; the weight ratio of the polyamide acid to the solvent is in a range of from about 1:4.5 to about 1:10; and the weight ratio of the polyamide acid to the solidifying agent is in a range of from about 1:20 to about 1:200.

20. A lithium battery comprising:
a shell;
an anode;
a cathode;
an electrolyte in contact with the anode and the cathode; and
at least one separator disposed between the anode and the cathode;
wherein the anode, the cathode, the electrolyte, and the separator are disposed in the shell; and the shell is sealed; and
wherein the separator comprises a porous polyimide membrane,
wherein the volume of the pores with a diameter of about 50-300 nm is more than about 40% of the total pore volume.
